(19) United States
(12) Patent Application Publication
(10) Pub. No.: US 2022/0178181 A1
(43) Pub. Date: Jun. 9, 2022

(54) ADJUSTABLE BAFFLE AND DOORFRAME HAVING THE ADJUSTABLE BAFFLE

(71) Applicant: TAIWAN FU HSING INDUSTRIAL CO., LTD., Kaohsiung City (TW)

(72) Inventor: CHING-WAN LEE, KAOHSIUNG CITY (TW)

(21) Appl. No.: 17/529,702

(22) Filed: Nov. 18, 2021

(30) Foreign Application Priority Data
Dec. 9, 2020 (TW) 109143476

(51) Int. Cl. E05C 9/00; E05B 15/02

(52) U.S. Cl. CPC E05C 9/004; E05B 15/02

(57) ABSTRACT

An adjustable baffle includes a base having a room formed in its rear side, and a first through hole is defined through the base. A baffle is located in the room and movable in at least one movement direction within the room of the base. An elastic element is located to at least one side of the baffle that faces the at least one movement direction. The baffle includes a second through hole that is smaller than the first through hole. The baffle includes a guide face formed on one face thereof and located along the periphery of the second through hole. By the movable baffle, the lock latch of a door is guided by the guide face so that the lock latch can easily and smoothly insert into the recess of the doorframe.

### BACKGROUND OF THE INVENTION

### 1. Fields of the invention

The present invention relates to an adjustable baffle and a doorframe having the adjustable baffle, the adjustable baffle allows the door lock to be smoothly operated relative to the doorframe.

### 2. Descriptions of Related Art

Generally, a door lock is installed to a door, and the doorframe includes a recess in which a baffle is installed, so that the door lock is inserted into or removed from the recess of the doorframe via the baffle to lock the door or to unlock the door.

The baffle installed to the doorframe includes a through hole which is located corresponding to the latch of the door lock. The latch of the door lock extends through the through hole of the baffle when the door is locked. The baffle prevents the door latch to hit or scratch the periphery of the recess of the doorframe.

The baffle usually is a single plate, and the through hole of the baffle is shaped to be compatible to the shaped of the door latch, so that the through hole of the baffle is matched with the door latch. However, the doorframe may be deformed slightly due to change of humidity and temperature and the door latch cannot perfectly extend through the through hole of the baffle. The users need to forcibly push or hit the door to ensure that the door latch extends through the through hole of the baffle, and this is disturbing for the users. In order to improve the situation, a new doorframe may be needed, or the baffle and the recess in the doorframe need to be re-positioned. Sometimes this could involve high cost or complicated work. Besides, if the users want to remove the old baffle and install a new baffle, a precise installation is expected and some users may not be able to achieve the expected installation.

The present invention intends to provide an adjustable baffle and a doorframe having the adjustable baffle, to eliminate the shortcomings mentioned above.

### SUMMARY OF THE INVENTION

The present invention relates to an adjustable baffle and comprises a base having a room formed in the rear side thereof. A first through hole is defined through the base and located corresponding to the room. A baffle is located in the room and has a second through hole located corresponding to the first through hole of the base. The baffle is movable in at least one movement direction within the room of the base. An elastic element is located between the base and at least one side of the baffle along the at least one movement direction.

Preferably, the first and second through holes accommodates a door latch. The at least one movement direction of the baffle is perpendicular to the movement direction of the door latch. The length of the second through hole of the baffle along the at least one movement direction is smaller than the length of the first through hole along the at least one movement direction.

Preferably, the elastic element is a curve plate.

Preferably, there are two elastic elements which are located to two opposite sides of the baffle along the at least one movement direction and the base 1 respectively.

Preferably, the baffle includes a guide face formed on one face thereof and located along the periphery of the second through hole.

Preferably, the guide face is an inclined face or a curve face.

Preferably, the base includes a notch defined in one end thereof. A cover is attached to the rear side of the base and engaged with the notch. The cover includes a third through hole which is located corresponding to the first through hole.

Preferably, the base includes at least one first bore. The cover includes a second bore located corresponding to the at least one first bore. At least one connector is connected to the at least one first bore and the second bore.

Preferably, the at least one first bore and the second bore both are a hole. The at least one connector is a positioning part.

Preferably, the at least one connector includes a passage defined centrally therethrough so that a bolt extends through the passage.

Preferably, the baffle includes a slot which is located corresponding to the at least one connector.

Preferably, the slot extends along the at least one movement direction, the at least one connector extends through the slot

The present invention provides a doorframe that includes a recess. An adjustable baffle is located in the recess. The adjustable baffle comprises a base and a baffle. The base has a room formed in the rear side thereof. A first through hole is defined through the base. The first through hole is larger than the recess. The baffle is located in the room and has a second through hole which is located corresponding to the first through hole of the base. The second through hole is smaller than the first through hole. The baffle is movable in at least one movement direction within the room of the base. An elastic element is located between the base and at least one side of the baffle along the at least one movement direction.

The advantages of the present invention are that the baffle is movable in the movement direction within the room of the base so that when installing the door lock and they baffle, the tolerance between the lock latch and the recess of the doorframe, and the tolerance between the lock latch and the second through holes of the baffle can be corrected and adjusted by the baffle being moved by compressing the elastic element. The lock latch is then guided by the guidance of the guide face of the baffle to precisely and properly extend through the second through holes so that the lock latch is able to be inserted into the recess in the doorframe smoothly. In addition, by the elastic element, the baffle and the lock latch do not hit and interfere with each other when the lock latch is inserted into or removed from the recess of the doorframe.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the baffle of the present invention;

FIG. 2 is an exploded view of the baffle of the present invention;

FIG. 3 is another exploded view of the baffle of the present invention;

FIG. 4 shows that the lock latch is offset relative to the second through hole of the baffle;

FIG. 5 shows that the lock latch presses the guide face of the baffle so as to move the baffle to a position where the lock latch is aligned with the second through hole of the baffle, and the lock latch extends through the second hole of the baffle;

FIG. 6 shows that the lock latch is offset relative to the recess of the doorframe, and

FIG. 7 shows that the lock latch presses the guide face of the baffle so that the lock latch is aligned with the recess of the doorframe, and the lock latch is inserted into the recess of the doorframe.

### DETAILED DESCRIPTION OF THE PREFERRED EMBODIMENT

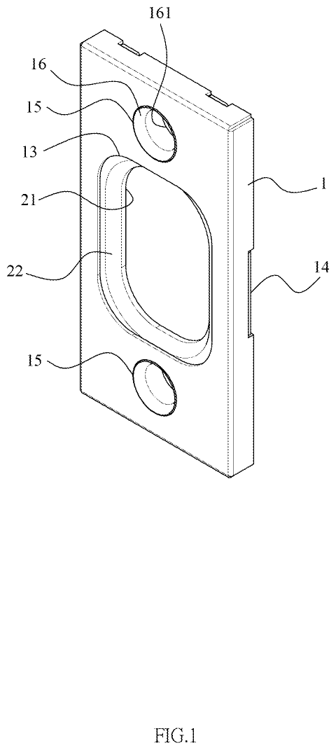

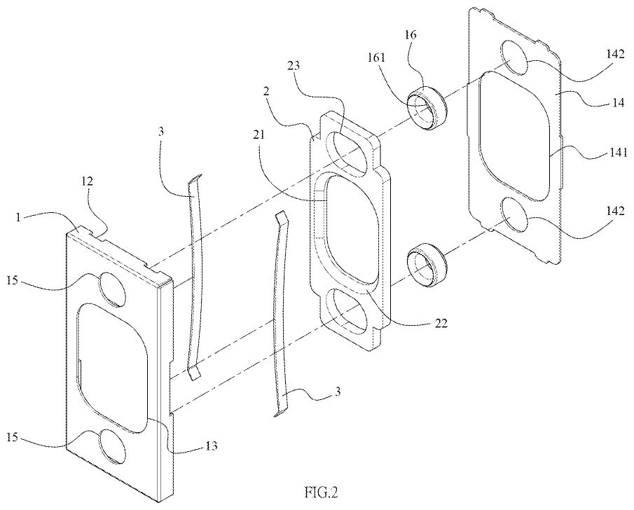

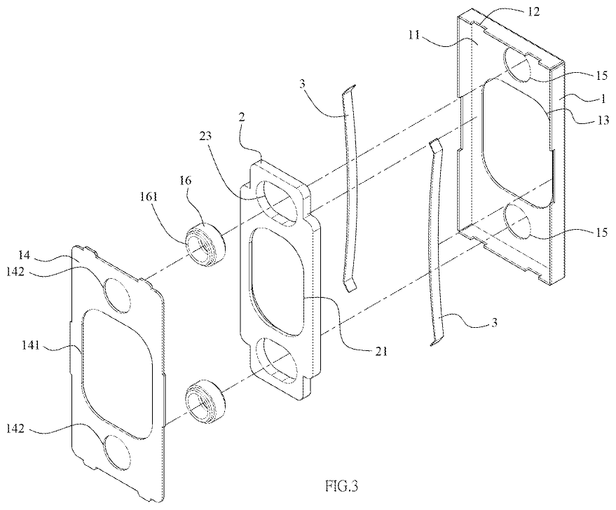

Referring to FIGS. 1 to 3, the adjustable baffle of the present invention comprises a base 1 having a room 11 formed in the rear side thereof, and two notches 12 are defined in each one of two ends of the base 1. A first through hole 13 is defined through the base 1.

A baffle 2 is located in the room 11 and can be movable in at least one movement direction within the room 11 of the base 1. An elastic element 3 is located between the base 1 and at least one side of the baffle 2 along the at least one movement direction. In this embodiment, there are two elastic elements 3 but not limited thereto. The two elastic elements 3 are located to two opposite sides of the baffle 2 along the at least one movement direction and the base 1 respectively. A second through hole 21 is defined through the baffle 2 and located corresponding to the first through hole 13 of the base 1. The length of the second through hole 21 of the baffle 2 along the at least one movement direction is smaller than the length of the first through hole 13 along the at least one movement direction.

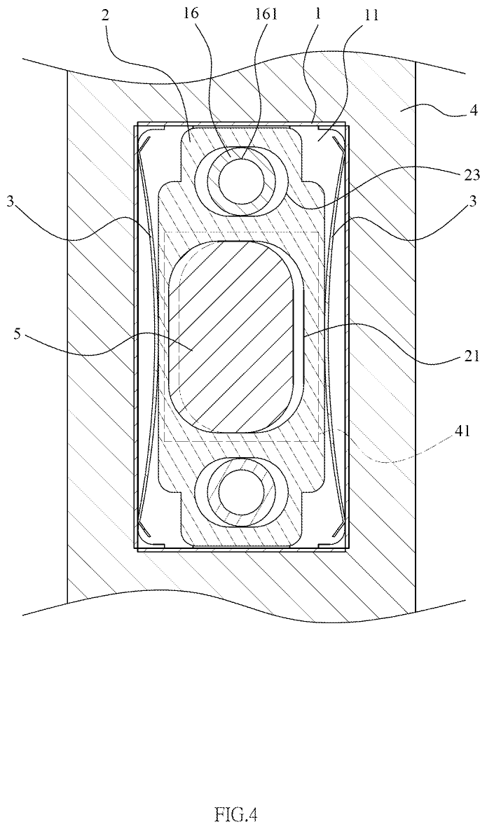

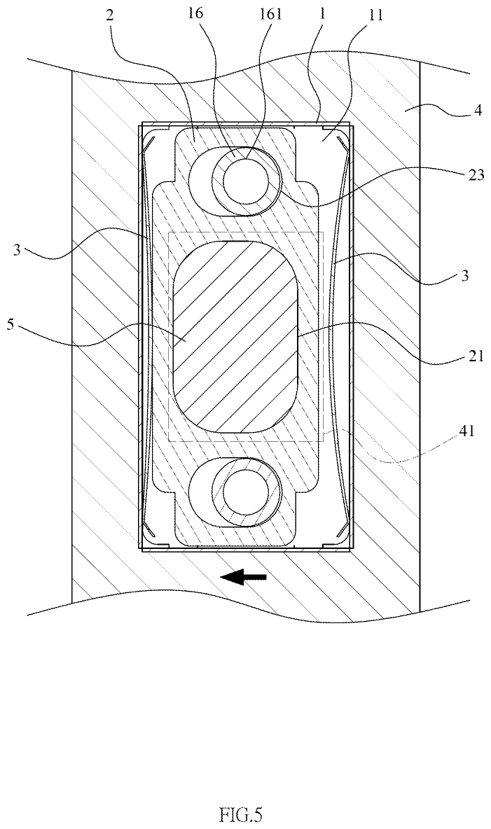

The base 1 is installed to a recess 41 of a doorframe 4. A door (not shown) is pivotably connected to the doorframe 4 and includes a door lock (as shown in FIGS. 4 and 5). The door lock includes a door latch 5, when the door is locked, the lock latch 5 extends through the first and second through holes 13, 21, and is inserted into the recess 41 of the doorframe 4. However, when the lock latch 5 is not in alignment with the second through hole 21, the lock latch 5 protrudes slightly beyond the second through hole 21, or contacts the insides of the second through hole 21, the second through hole 21 can be moved to allow the lock latch 5 to be extended through position the second through hole 21 without interference. It is noted that the at least one movement direction of the baffle 2 is perpendicular to a movement direction of the door latch 5. Therefore, the corresponding elastic element 3 is compressed by the movement of the baffle 2 to adjust the second through hole 21 to be aligned with the lock latch 5, such that the lock latch 5 is inserted into the recess 41 of the doorframe 4 via the second through hole 21 of the baffle 2.

In this embodiment, the baffle 2 includes a guide face 22 formed on one face thereof and located along the periphery of the second through hole 21. The guide face 22 is an inclined face, the inner periphery of the second through hole 21 gradually widens from one of the two ends of the baffle 2 that is remote to the door toward another one of the two ends of the baffle 2 that is close to the door. By the guide face 22, when the lock latch 5 is offset relative to the second through hole 21 of the baffle 2, as shown in FIG. 5, the lock latch 5 pushes the guide face 22 to move the baffle 2 relative to the base 1 until the second through hole 21 is in alignment with the lock latch 5. Therefore, the lock latch 5 can precisely extend through the second through hole 21 of the baffle 2. Besides, because the guide face 22 is an inclined face, and the inner periphery of the second through hole 21 gradually widens from one of the two ends of the baffle 2 that is remote to the door toward another one of the two ends of the baffle 2 that is close to the door, so that during the pushing action that the lock latch 5 pushes the guide face 22, the baffle 2 is smoothly guided to move relative to the base 1. It is noted that, in other embodiments, the guide face 22 can be a curve face, and the inner periphery of the second through hole 21 gradually widens from one of the two ends of the baffle 2 that is remote to the door toward another one of the two ends of the baffle 2 that is close to the door, or, in other embodiments, the guide face 22 can be omitted, and as long as the lock latch 5 slightly protrudes beyond the second through hole 21 and contacts the baffle 2, the baffle 2 can be moved to allow the lock latch 5 to extends through the second through hole 21 to achieve the same function.

The size of the first through hole 13 is larger than the second through hole 21, and larger than the cross section of the lock latch 5 as shown in FIG. 4. Preferably, the size of the first through hole 13 is 1.2 to 2 times of the size of the lock latch 5. When the doorframe 4 is deformed due to change of humidity and temperature, or poor installation, the lock latch 5 can pass through the first through hole 13 even when the doorframe 4 is slightly deformed. The size of the second through hole 21 is slightly larger than the size of the lock latch 5 so that the lock latch 5 can extend through. By the guide face 22, when the lock latch 5 is not inserted into the second through hole 21, and when the baffle 2 and the elastic elements 3 are not applied by a force, the inner periphery of the guide face 22 that is located close to the door is located corresponding to the inner periphery of first through hole 13 projected to the baffle 2. Therefore, in this embodiment, the guide face 22 is an inclined face, such that, when the lock latch 5 is located corresponding to the first through hole 13, by the guidance of the guide face 22, the baffle 2 is moved. As shown in FIGS. 4 and 5, the lock latch 5 slightly protrudes beyond the second through hole 21 and is located at the left side of the second through hole 21 as shown in FIG. 4. By the lock latch 5 pressing the guide face 22, the baffle 2 moves from the position shown in FIG. 4 to the position shown in FIG. 5. The lock latch 5 can extend through the second through hole 21 and insert into the recess 41 of the doorframe 4.

This feature allows the lock latch 5 to be inserted into the recess 41 of the doorframe 4 as expected when a poor or un-experienced installation happens, as long as the lock latch 5 is located in the first through hole 13. When the adjustable baffle is used for electronic lock, the lock latch 5 is driven by a motor, the movable baffle provides solutions to poor installation or mis-alignment between the lock latch 5 and the recess 41 of the doorframe 4. As long as the lock latch 5 extends through the first through hole 13, the doorframe 4 does not need to be adjusted or re-installed, and the door with the door lock do not need to be re-installed.

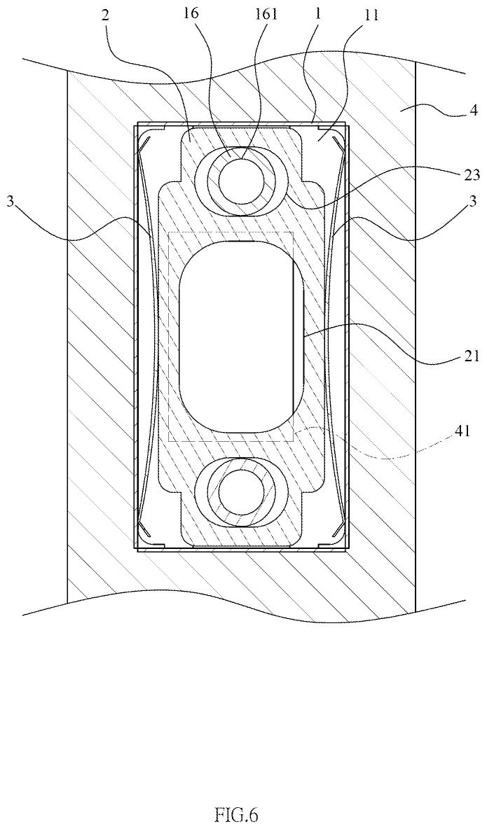

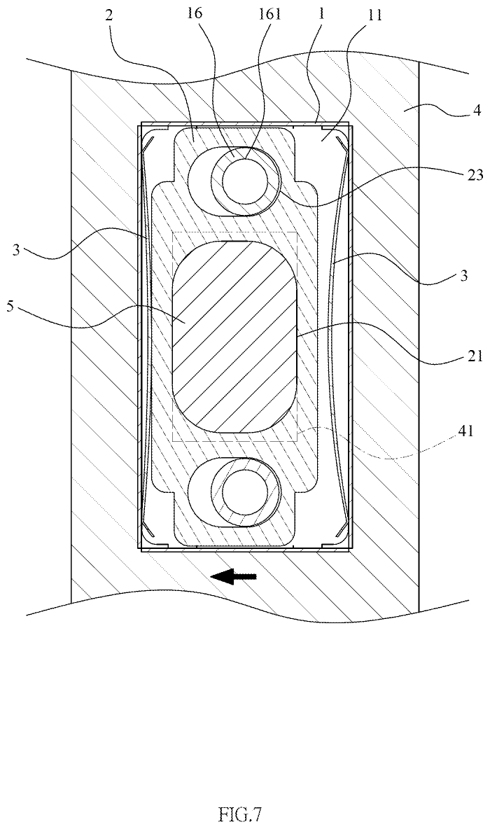

As shown in FIG. 6, when the doorframe 4 is deformed as mentioned above, and the lock latch 5 cannot be aligned with the recess 41 of the doorframe 4, the lock latch 5 cannot be the inserted into the recess 41 of the doorframe 4. However, when there is a tolerance less than 1 mm, for example, between the lock latch 5 and the recess 41 of the doorframe 4, the lock latch 5 still contacts the guide face 22, the lock latch 5 moves and guided by the guide face 22 by the transmission force of the door lock, and generally, the lock latch 5 can be slightly moved in the direction perpendicular to the axis of the lock latch 5, so that as shown in FIG. 7, the lock latch 5 is guided by the guide face 22 and eventually is inserted into the recess 41 of the doorframe 4.

On the contrary, when the lock latch 5 is removed from the second through hole 21, by the guidance of the guide face 22 and the operation of the elastic elements 3, the lock latch 5 is easily removed from the base 1 and the baffle 2. Therefore, door latch 5 is smoothly and easily operated between lock and unlock actions.

In this embodiment, each elastic element 3 is a single spring strip, and two ends of each elastic element 3 contacts against the base 1, and the middle portion of each elastic element 3 contacts the baffle 2 and which provides a recovery force to the baffle 2 and avoids the baffle 2 from being inclined during movements of recovery and shifting.

As described above, the elastic elements 3 are used to avoid the baffle 2 from being inclined during movements of recovery and shifting. Preferably, the elastic elements 3 are curved strips. The directions that the force applied to the baffle 2 are left and right, so that the movement direction of the baffle 2 is left and right when facing the front side of the baffle 2. In one embodiment, the elastic elements 3 are located to two opposite sides of the baffle 2 along the movement direction and the base 1 respectively. In one embodiment, only one elastic element 3 located between one side of the baffle 2 and the base 1. Alternatively, one elastic element 3 is located between each of the top end and the bottom end of the baffle 2.

A cover 14 is attached to the rear side of the base 1 and engaged with the notches 12 so as to position the baffle 2. The cover 14 includes a third through hole 141 which is located corresponding to the first through hole 13. The base 1 includes at least one first bore 15. The cover 14 includes at least one second bore 142 located corresponding to the at least one first bore 15. In this embodiment, the base 1 includes two first bores 15, and the cover 14 includes two second bores 142. The at least one first bore 15 and the at least one second bore 142 both are a hole, and the at least one connector 16 is a positioning part. In one embodiment, the at least one connector 16 can be a ring-shaped connector and includes a passage 161 defined centrally therethrough so that a bolt (not shown) extends through the passage 161 and is connected to the doorframe 4. The head of the bolt contacts against the at least one connector 16 to fix the adjustable baffle to the doorframe 4.

In order to prevent the connectors 16 from being interfered to the baffle 2, the baffle 2 includes two slots 23 which are located corresponding to the connectors 16 and extend in the movement direction mentioned above. The slots 23 extend along the at least one movement direction, the connectors 16 extend respectively through the slots 23. When the baffle 2 is moved, the connectors 16 move within the slots 23.

While we have shown and described the embodiment in accordance with the present invention, it should be clear to those skilled in the art that further embodiments may be made without departing from the scope of the present invention.

What is claimed is:

1. An adjustable baffle comprising:
a base (1) having a room (11) formed in a rear side thereof, a first through hole (13) defined through the base (1) and located corresponding to the room (11), and
a baffle (2) located in the room (11) and having a second through hole (21) which is located corresponding to the first through hole (13) of the base (1), the baffle (2) being movable in at least one movement direction within the room (11) of the base (1), an elastic element (3) located between the base (1) and at least one side of the baffle (2) along the at least one movement direction.

2. The adjustable baffle as claimed in claim 1, wherein the first and second through holes (13, 21) are adapted to accommodate a door latch (5), the at least one movement direction of the baffle (2) is adapted to be perpendicular to a movement direction of the door latch (5), a length of the second through hole (21) of the baffle (2) along the at least one movement direction is smaller than a length of the first through hole (13) along the at least one movement direction.

3. The adjustable baffle as claimed in claim 1, wherein the elastic element (3) is a curve plate.

4. The adjustable baffle as claimed in claim 1, wherein there are two elastic elements (3) which are located to two opposite sides of the baffle (2) along the at least one movement direction and the base (1) respectively.

5. The adjustable baffle as claimed in claim 1, wherein the baffle (2) includes a guide face (22) formed on one face thereof and located along a periphery of the second through hole (21).

6. The adjustable baffle as claimed in claim 5, wherein the guide face (22) is an inclined face or a curve face.

7. The adjustable baffle as claimed in claim 1, wherein the base (1) includes a notch (12) defined in one end thereof, a cover (14) attached to the rear side of the base (1) and engaged with the notch (12), the cover (14) includes a third through hole (141) which is located corresponding to the first through hole (13).

8. The adjustable baffle as claimed in claim 7, wherein the base (1) includes at least one first bore (15), the cover (14) includes a second bore (142) located corresponding to the at least one first bore (15), at least one connector (16) is connected to the at least one first bore (15) and the second bore (142).

9. The adjustable baffle as claimed in claim 8, wherein the at least one first bore (15) and the second bore (142) both are a hole, the at least one connector (16) is a positioning part.

10. The adjustable baffle as claimed in claim 9, wherein the at least one connector (16) includes a passage (161) defined centrally therethrough so that a bolt extends through the passage (161).

11. The adjustable baffle as claimed in claim 8, wherein the baffle (2) includes a slot (23) which is located corresponding to the at least one connector (16).

12. The adjustable baffle as claimed in claim 11, wherein the slot (23) extends along the at least one movement direction_{;} the at least one connector (16) extends through the slot (23).

13. A doorframe (4) comprising a recess (41), an adjustable baffle located in the recess (41), the adjustable baffle comprising a base (1) and a baffle (2), the base (1) having a room (11) formed in a rear side thereof, a first through hole (13) defined through the base (1), the first through hole (13) being larger than the recess (41), the baffle (2) located in the room (11) and having a second through hole (21) which is located corresponding to the first through hole (13) of the base (1), the second through hole (21) being smaller than the first through hole (13), the baffle (1) being movable in at least one movement direction within the room (11) of the base (1), an elastic element (3) located between the base (1) and at least one side of the baffle (2) along the at least one movement direction.
